(19) United States
(12) Patent Application Publication
(10) Pub. No.: US 2022/0065042 A1
(43) Pub. Date: Mar. 3, 2022

(54) SAFETY APPARATUS

(71) Applicant: Robert Warren Shiver, Eclectic, AL (US)

(72) Inventor: Robert Warren Shiver, Eclectic, AL (US)

(21) Appl. No.: 17/008,161

(22) Filed: Aug. 31, 2020

(51) Int. Cl. E06C 1/34; E06C 1/12; E06C 1/38

(52) U.S. Cl. CPC E06C 1/34; E06C 1/10; E06C 1/381; E06C 1/12

(57) ABSTRACT

A safety apparatus used in connection with ladder stands is disclosed. The safety apparatus can include a structure attachment component configured to securely attach to a structure, a ladder stand attachment component configured to couple to a ladder stand of a ladder stand, and a bracing member that couples the structure attachment component to the ladder stand attachment component so as to resist lateral movement of the ladder stand with respect to the structure when the structure attachment component is secured to the structure.

### FIELD

The present invention relates generally to ladder stands. More particularly, the present invention relates to a safety apparatus for use in connection with a ladder stand.

### BACKGROUND

Known ladder stands such as the ladder stand 10 shown in FIG. 1 are secured to a tree or other structure 12 only at the very top section of the ladder stand 10. This arraignment can lead to difficulty installing such known ladder stands and can pose serious safety issues during their installation and operation. Specifically, when an installer ascends the ladder stand 10 to the top of the stand 10 to secure the stand 10 to the structure 12, nothing secures the stand 10 in place other than other installers on the ground until the installer at the top of the stand 10 secures the stand to the structure 12 with a ratchet strap or other similar mechanism. This can be a lot of weight for the installers on the ground to hold. Furthermore, the weight of the installer leaning towards the tree to attach the ratchet strap thereto can cause the stand to move downwards and/or shift. These problems can result in a very dangerous condition of the ladder stand falling away from the structure 12 and injuring the installer, which can also occur when the ladder stand is taken down.

One known solution to this problem includes an integrated multiple component safety rail and ladder stand combination that secures the midpoint of the ladder stand to the tree or structure during the setup, operation, and disassembly phases. However, this solution requires an integrated ladder stand and is not readily adaptable to existing ladder stands that do not presently include a reliable safety apparatus.

In view of the above, there is a continuing, ongoing need for a safety apparatus that is operable with existing ladder stands to increase the safe operation thereof.

### BRIEF DESCRIPTION OF THE DRAWINGS

FIG. 1 is a perspective view of a known ladder stand;

FIG. 2 is a top view of a safety apparatus in accordance with disclosed embodiments;

FIG. 3 is a is a top view of a portion of safety apparatus in accordance with disclosed embodiments;

FIG. 4 is a is a top view of a portion of safety apparatus in accordance with disclosed embodiments;

FIG. 5 is perspective view of the safety apparatus coupled to a structure according to disclosed embodiments; and

FIG. 6 is perspective view of the safety apparatus coupled to a ladder stand according to disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a safety apparatus that can be used in connection with known ladder stands. In some embodiments, the safety apparatus can be used for the safe installation, operation, and/or take down of a ladder stand.

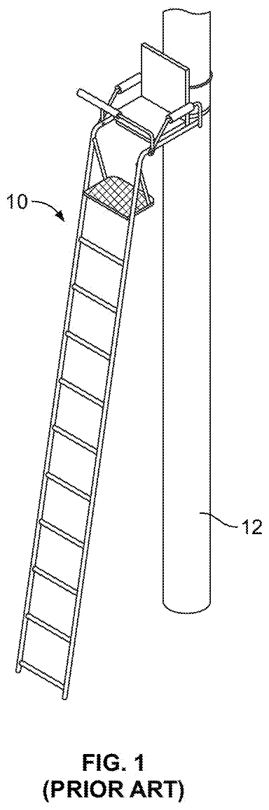

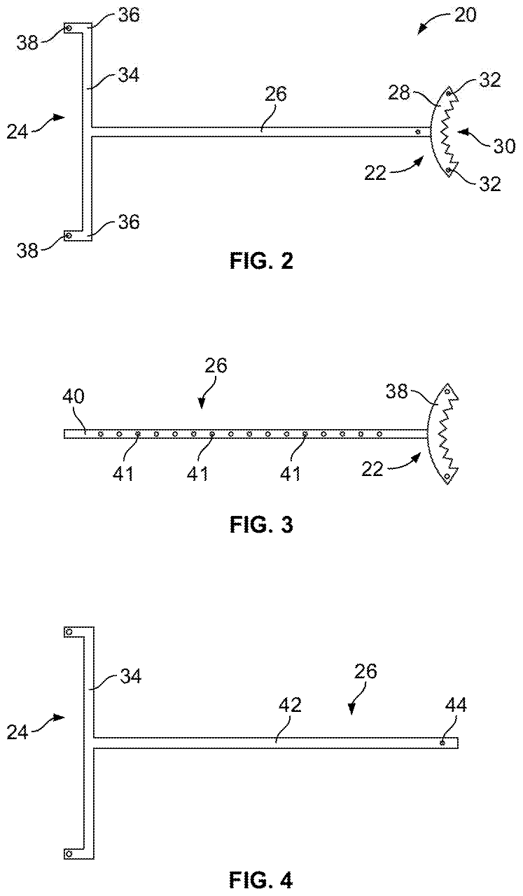

FIG. 2 is a top view of a safety apparatus 20 for a ladder stand such as the ladder stand 10 shown in FIG. 1. As seen in FIG. 2, in some embodiments, the safety apparatus 20 can include a structure attachment component 22, a ladder stand attachment component 24, and a bracing member 26 that couples the structure attachment component 22 to the ladder stand attachment component 24. In operation, the structure attachment component 22 can be configured to securely attach to a structure such as the structure 12 of FIG. 1, the ladder stand attachment component 24 can be configured to couple to a ladder stand, and the bracing member can secure the ladder stand to the structure when the structure attachment component 22 is secured thereto and resist or limit lateral movement of the ladder stand with respect to the structure. Various materials are contemplated for the components of the safety apparatus 20, which in some embodiments can include reinforced steel or similar metal materials that resist lateral movement.

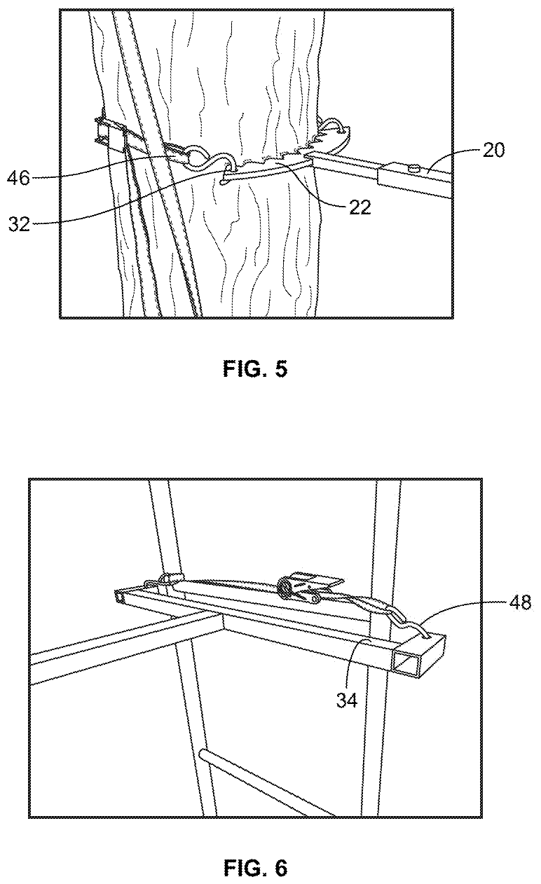

In some embodiments, the structure can include a tree. In these embodiments, the structure attachment component 22 can include a plurality of teeth 30 located on a head portion 28 of the structure attachment component 22. In some embodiments, the plurality of teeth 30 can be configured to at least partially embed into an outer surface of the tree when the structure attachment component is secured to the tree. Additionally or alternatively, in some embodiments, the head portion 28 can include a concave shape that can allow the structure attachment component 22 to better conform to the cylindrical outer surface of the tree. However, it should be noted that other shapes for the head portion 28 as would be known in the art are also contemplated. Furthermore, in some embodiments, the structure attachment component 22 can include fastening holes or slots 32 that are configured to receive a ratchet strap 46 or similar device to assist in tightening the head potion 28 and the plurality of teeth 30 into the outer surface of the tree as shown in FIG. 5.

In some embodiments, the ladder stand attachment component 24 can include a support member 34 coupled perpendicular to the bracing member 26. Furthermore, as seen in FIG. 2 the ladder stand attachment component 24 can include first and second arms 36 on opposing ends of the support member 26 that are configured to couple the ladder stand attachment component 24 to the ladder stand. in some embodiments, the ladder stand attachment component 24 can include fastening holes or slots 38 that are configured to receive a ratchet strap, pin, bolt, screw, or similar fastener 48 to assist in coupling the first and second arms 36 to the ladder stand as shown in FIG. 6.

In some embodiments, the bracing member 26 can include an adjustable length that can enable the safety apparatus 20 to accommodate different distances between the structure and the ladder stand that can result from different ladder stand parameters such as height and operating angle with respect to the support structure. For example, as seen in FIG. 3 and FIG. 4, in some embodiments, the bracing member 26 can include first and second telescoping members 40 and 42. As seen in FIG. 3, the first telescoping member 40 and can include a plurality of first fastening holes or slots 41 that correspond to different possible lengths for the bracing member 26. However, it should be noted that alternative methods for altering the length of the bracing member 26 to accommodate the different ladder stand parameters such as coupling together and decupling sections of various lengths are contemplated.

Furthermore, as seen in FIG. 4, in some embodiments, the second telescoping member 42 can include one or more second fastening holes or slots 44 for securing the second telescoping member 42 to the first telescoping member 40 through at least one of the plurality of fastening holes or slots 41 and the one or more fastening holes or slots 44 with fastening elements such as a pin, bolt, screw, etc. In operation, one of the first and second telescoping members 40 and 42 can be configured to fit inside of and extend and retract with respect to the other of the first and second telescoping members 40 and 42 so as to increase or decrease the length of the bracing member 26. In some embodiments, such as shown in FIG. 3 and FIG. 4, the first telescoping member 40 can be coupled or welded to the head portion 28 of the structure attachment component 22 and the second telescoping member 42 can be coupled or welded to the head portion 28.

Similarly, in some embodiments, the ladder stand attachment component 24 can include an adjustable width between the first and second arms 36 so as to accommodate different widths of known ladder stands. In some embodiments, the ladder stand attachment component 24 can include a telescoping member that is configured to alter the width thereof. However, various other embodiments for adjusting the width of the ladder stand attachment component 24 are also contemplated.

Furthermore, the embodiments described herein can be directed to a method for installing the security apparatus 20 described above. For example, in some embodiments such a method can include at least securing the structure attachment component 22 to a structure, adjusting the length of the bracing member 26 to one of the plurality of lengths corresponding to a distance between the structure and a ladder stand, and securing the ladder stand attachment component 24 to the ladder stand.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the sprit and scope of the invention.

What is claimed is:

1. An apparatus comprising:
a structure attachment component configured to securely attach to a structure;
a ladder stand attachment component configured to couple to a ladder stand; and
a bracing member that couples the structure attachment component to the ladder stand attachment component,
wherein the bracing member secures the ladder stand to the structure when the structure attachment component is secured thereto and resists lateral movement of the ladder stand with respect to the structure.

2. The apparatus of claim 1 wherein the structure attachment component includes a plurality of teeth configured to at least partially embed into an outer surface of the structure when the structure attachment component is secured to the structure.

3. The apparatus of claim 1 wherein the structure attachment component includes a concave head portion configured to attach to the structure.

4. The apparatus of claim 1 wherein the bracing member includes a telescoping component configured to alter a length of the bracing member to accommodate multiple distances between the structure and the ladder stand.

5. The apparatus of claim 4 further comprising a fastening element configured to secure the telescoping component to the bracing member in any of a plurality of positions that correspond to the multiple distances.

6. The apparatus of claim 1 wherein the ladder stand attachment component includes a telescoping component configured to alter a width of the ladder stand attachment component to accommodate a plurality of different widths for the ladder stand.

7. The apparatus of claim 1 wherein the ladder stand attachment component includes a support member perpendicular to the bracing member that couples the ladder stand attachment component to the bracing member and wherein the ladder stand attachment component includes first and second arms on opposing ends of the support member that are configured to couple the ladder stand attachment component to the ladder stand.

8. The apparatus of claim 7 further comprising first and second fastening elements configured to respectively secure the first and second arms to the ladder stand.

9. The apparatus of claim 7 wherein the first and second fastening elements include first and second slots configured to accommodate a ratchet strap for securing the ladder stand attachment component to the ladder stand.

10. The apparatus of claim 1 wherein the structure attachment component includes slots configured to accommodate a ratchet strap for securing the structure attachment component to the structure.

11. A method comprising:
securing a structure attachment component of a safety apparatus to a structure;
adjusting a length of a bracing member of the safety apparatus to one of a plurality of lengths corresponding to a distance between the structure and a ladder stand;
securing a ladder stand attachment component of the safety apparatus to the ladder stand, the ladder stand attachment component being coupled to the bracing member opposite the structure attachment component
wherein the bracing member secures the ladder stand to the structure when the structure attachment component is secured thereto and resists lateral movement of the ladder stand with respect to the structure.

12. The method of claim 11 further comprising embedding a plurality of teeth configured of the structure attachment component at least partially embed into an outer surface of the structure when securing structure attachment component to the structure.

13. The method of claim 11 wherein the structure attachment component includes a concave head portion configured to attach to the structure.

14. The method of claim 11 further comprising adjusting the length of the bracing member by extending or retracting a telescoping component of the bracing member to the one of a plurality of lengths.

15. The method of claim 14 further comprising inserting fastening element into the telescoping component to secure the telescoping component the one of a plurality of lengths.

16. The method of claim 11 further comprising extending or retracting a telescoping component of the ladder stand attachment component to alter a width of the ladder stand attachment component to accommodate a width of the ladder stand.

17. The method of claim 11 further comprising securing ladder stand attachment component to the ladder stand by coupling first and second arms of the ladder stand attachment component to the ladder stand, wherein the ladder stand attachment component includes a support member perpendicular to the bracing member, and wherein first and second arms reside on opposing ends of the support member.

18. The method of claim 17 further comprising:
feeding a ratchet strap through first and second slots of the first and second arms;
and tightening the ratchet strap to secure the ladder stand attachment component to the ladder stand.

19. The method of claim 11 further comprising:
feeding a ratchet strap through first and second slots of the structure attachment component; and
tightening the ratchet strap to secure the structure attachment component to the structure.

20. A system comprising:
a ladder stand; and
a safety apparatus comprising a structure attachment component configured to securely attach to a structure, a ladder stand attachment component coupled to a midpoint of the ladder stand, and a bracing member that couples the structure attachment component to the ladder stand attachment component,
wherein the bracing member secures the ladder stand to the structure when the structure attachment component is secured thereto and resists lateral movement of the ladder stand with respect to the structure.
